(19) United States
(12) Patent Application Publication
(10) Pub. No.: US 2023/0195669 A1
(43) Pub. Date: Jun. 22, 2023

(54) ACCESS ARBITRATION SYSTEM AND METHOD FOR PLURALITY OF I2C COMMUNICATION-BASED MASTER DEVICES

(71) Applicant: Celestica Technology Consultancy (Shanghai) Co. Ltd, Shanghai (CN)

(72) Inventors: Longwu TONG, Shanghai (CN); Zhongfu HUANG, Shanghai (CN)

(73) Assignee: Celestica Technology Consultancy (Shanghai) Co. Ltd, Shanghai (CN)

(21) Appl. No.: 17/834,886

(22) Filed: Jun. 7, 2022

(30) Foreign Application Priority Data
Dec. 16, 2021 (CN) 202111544296X

(51) Int. Cl. G06F 13/366

(52) U.S. Cl. CPC G06F 13/366; G06F 2213/0016

(57) ABSTRACT

The present disclosure provides an access arbitration system and method for a plurality of I2C communication-based master devices. The system includes: a slave device; a plurality of master devices, respectively connected to the slave device through I2C buses; and an arbitration logic controller, respectively connected to the plurality of master devices. When the master devices need to access the slave device, the master devices send access requests for an I2C bus access permission to the arbitration logic controller, the arbitration logic controller determines, based on the access requests of the master devices, the master device that establishes a communication connection with the slave device, and sends a connection confirmation instruction to the corresponding master device, and the master device that receives the connection confirmation instruction establishes the communication connection with the slave device. In the present disclosure, the reliability of system operation is improved.

### CROSS REFERENCE TO RELATED APPLICATION

The present application claims the benefit of priority to Chinese Patent Application No. CN202111544296X, entitled “Access Arbitration System and Method for Plurality of I2C Communication-Based Master Devices”, filed with CNIPA on Dec. 16, 2021, the content of which is incorporated herein by reference in its entirety.

### FIELD OF THE TECHNOLOGY

The present disclosure relates to the field of device control technologies, and in particular, to the field of redundant control technologies.

### BACKGROUND

At present, when a plurality of controls is redundantly designed in servers and memories, it often occurs that a plurality of inter-integrated circuit (I2C) master devices accesses a slave device, which can lead to access conflicts, and severe conflicts may cause the entire I2C loop to crash. The I2C protocol supports communication between the plurality of master devices, but is unreliable. To avoid the conflicts caused by the plurality of I2C master devices accessing the slave device simultaneously, it is necessary to design a method for arbitrating an access permission of an I2C master device.

### SUMMARY OF THE PRESENT DISCLOSURE

The present disclosure provides an access arbitration system and method for a plurality of I2C communication-based master devices, to resolve the technical problem in the related art that access conflicts occur when the plurality of I2C master devices access a slave device.

The access arbitration system for a plurality of I2C communication-based master devices includes: a slave device; a plurality of master devices, respectively connected to the slave device through I2C buses; and an arbitration logic controller, respectively connected to the plurality of master devices. When the master devices need to access the slave device, the master devices send access requests for an I2C bus access permission to the arbitration logic controller, the arbitration logic controller determines, based on the access requests of the master devices, the master device that establishes a communication connection with the slave device, and sends a connection confirmation instruction to the corresponding master device, and the master device that receives the connection confirmation instruction establishes the communication connection with the slave device.

In an embodiment of the present disclosure, the access arbitration system for a plurality of I2C communication-based master devices includes a plurality of two access arbitration subsystems; each of the plurality of access arbitration subsystems includes a plurality of second master devices and a second arbitration logic controller connected to the plurality of second master devices; the second arbitration logic controllers in the plurality of access arbitration subsystems are in communication connection with each other; and the second master devices in the plurality of two access arbitration subsystems are respectively connected to the slave device through the I2C buses.

In an embodiment of the present disclosure, before establishing the communication connection with the slave device, the master device detects whether a current I2C bus is occupied by another master device, if the current I2C bus is not occupied by the another master device, the master device sends an access request for an I2C bus access permission to the arbitration logic controller, and if the current I2C bus is occupied by the another master device, after waiting for a preset time, the master device re-detects whether the current I2C bus is occupied by the another master device.

In an embodiment of the present disclosure, the master device sends the access request for the I2C bus access permission in a manner in which a register is read and written by a bus, or the master device sends the access request for the I2C bus access permission through a general-purpose input/output port.

In an embodiment of the present disclosure, an arbitration truth table is preset in the arbitration logic controller, and when receiving the access request from one of the plurality of master devices, the arbitration logic controller determines, based on the arbitration truth table, whether to allow the one of the plurality of master devices to establish a communication connection with the slave device.

In an embodiment of the present disclosure, when the access arbitration system for a plurality of I2C communication-based master devices includes at least two access arbitration subsystems, the arbitration truth table includes priorities of the access arbitration subsystems and priorities of the master devices in each of the access arbitration subsystems.

In an embodiment of the present disclosure, access priorities of the master devices are preset in the arbitration logic controller, and when receiving the access requests of at least two master devices, the arbitration logic controller determines, based on the access priorities of the master devices, the master device that establishes a communication connection with the slave device.

In an embodiment of the present disclosure, after executing a communication task, the master device that establishes the communication connection with the slave device sends a release request for releasing an I2C bus access permission to the arbitration logic controller, and when receiving the release request, the arbitration logic controller disconnects the communication connection between the master device and the slave device.

In an embodiment of the present disclosure, when receiving the release request sent by the master device, the arbitration logic controller determines, based on the access priorities of the master devices, a next master device that establishes a communication connection with the slave device.

An embodiment of the present disclosure further provides an access arbitration method for a plurality of I2C communication-based master devices, including: sending, when a plurality of master devices needs to access a same slave device, access requests for 2C bus access permissions by the master devices to an arbitration logic controller; determining, by the arbitration logic controller and based on the access requests of the master devices, the master device that establishes a communication connection with the slave device, and sending a connection confirmation instruction to the corresponding master device; and establishing, by the master device that receives the connection confirmation instruction, the communication connection with the slave device.

As described above, the access arbitration system and method for a plurality of I2C communication-based master devices of the present disclosure have the following beneficial effects.

In the present disclosure, a problem of access conflicts caused by a plurality of I2C master devices accessing a slave device simultaneously can be avoided, thereby improving the reliability of system operation.

### BRIEF DESCRIPTION OF THE DRAWINGS

FIG. 1 is a principle block diagram of an access arbitration system for a plurality of I2C communication-based master devices according to the present disclosure;

FIG. 2 is a preferred principle block diagram of an access arbitration system for a plurality of I2C communication-based master devices according to the present disclosure; and

FIG. 3 is a schematic flowchart of an access arbitration method for a plurality of I2C communication-based master devices according to the present disclosure.

### ELEMENT REFERENCE NUMERALS

100 Access arbitration system for a plurality of I2C communication-based master devices
110 Master device
120 Slave device
130 Arbitration logic controller
140 Master device
150 Arbitration logic controller
S110 to S130 Steps

### DETAILED DESCRIPTION OF THE PREFERRED EMBODIMENTS

The following describes implementations of the present disclosure by using specific embodiments. A person skilled in the art may easily understand other advantages and effects of the present disclosure from the content disclosed in this specification.

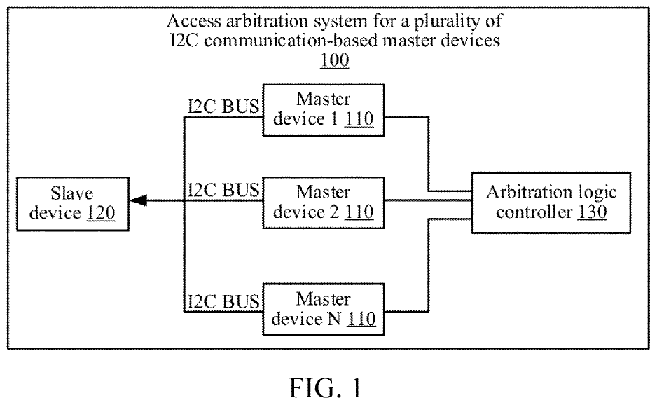

Refer to FIGS. 1 to 3. It should be noted that the structures, proportions, sizes, and the like shown in the drawings of the specification, in coordination with the content disclosed in the specification, are only used to help a person skilled in the art to read and understand, and they are not intended to limit the conditions under which the present disclosure can be implemented and therefore have no technical significance. Any modifications to the structure, changes to the proportional relationship or the adjustment on the size should fall within the scope of the technical content disclosed by the present disclosure without affecting the effects and the objectives that can be achieved by the present disclosure. In addition, the terms such as “top”, “bottom”, “left”, “right”, “middle”, and “a” mentioned in this specification are also merely for facilitating clear descriptions, but are not intended to limit the scope of implementation of the present disclosure. Without substantially changing the technical contents, changes or adjustments of relative relationships thereof should also fall within the scope of implementation of the present disclosure.

An embodiment provides an access arbitration system and method for a plurality of I2C communication-based master devices, to resolve the technical problem in the related art that access conflicts occur when the plurality of I2C master devices accesses a slave device.

Principles and implementations of the access arbitration system and method for the plurality of I2C communication-based master devices of the embodiments are to be described below in detail, so that a person skilled in the art can understand the access arbitration system and method for the plurality of I2C communication-based master devices of the embodiments.

As shown in FIG. 1, an embodiment provides an access arbitration system 100 for a plurality of I2C communication-based master devices, including at least a slave device 120, a plurality of master devices 110 (including a master device 1, a master device 2, . . . , and a master device N), and an arbitration logic controller 130.

In some embodiments of the present disclosure, the plurality of master devices 110 is respectively connected to the slave device 120 through I2C buses. In this embodiment, the arbitration logic controller 130 is respectively connected to the plurality of master devices 110, when the master devices 110 need to access the slave device 120, the master devices 110 send access requests for an I2C bus access permission to the arbitration logic controller 130, the arbitration logic controller 130 determines, based on the access requests of the master devices 110, the master device 110 that establishes a communication connection with the slave device 120, and sends a connection confirmation instruction to the corresponding master device 110, and the master device 110 that receives the connection confirmation instruction establishes the communication connection with the slave device 120.

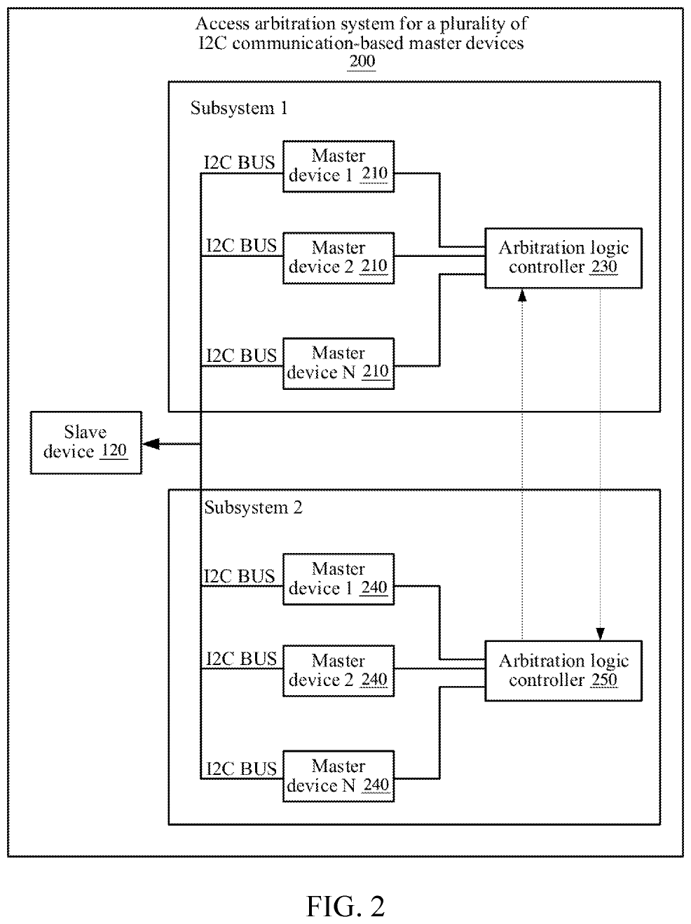

In some embodiments of the present disclosure, referring to FIG. 2, an access arbitration system 200 for a plurality of I2C communication-based master devices includes at least two access arbitration subsystems: a subsystem 1 and a subsystem 2. Each access arbitration subsystem includes a plurality of second master devices and a second arbitration logic controller connected to the plurality of second master devices; the second arbitration logic controllers in the access arbitration subsystems are in communication connection with each other; and the second master devices in the access arbitration subsystems are respectively connected to the slave device 120 through the I2C buses.

As shown in FIG. 2, the subsystem 1 includes a plurality of second master devices 210 (including a master device 1, a master device 2, . . . , and a master device N) and a second arbitration logic controller 230 connected to the plurality of second master devices 210. The subsystem 2 includes a plurality of second master devices 240 (including a master device 1, a master device 2, . . . , and a master device N) and a second arbitration logic controller 250 connected to the plurality of second master devices 240. The second arbitration logic controller 230 in the subsystem 1 is in communication connection with the second arbitration logic controller 250 in the subsystem 2; and the plurality of second master devices 210 in the subsystem 1 and the plurality of second master devices 240 in the subsystem 2 are respectively connected to the slave device 120 through the I2C buses.

Compared with an implementation method of current main and standby systems (based on a case that both a system 1 and a system 2 are in place, only the system 1 accesses a slave device, and the system 2 does not access the slave device), in the access arbitration system 100 for a plurality of I2C communication-based master devices of this embodiment, the master devices in the subsystem 1 and the subsystem 2 all have permissions to access the slave device 120, thereby having higher reliability.

A communication process of the slave device 120, the plurality of master devices 110, and the arbitration logic controller 130 in the access arbitration system 100 for a plurality of I2C communication-based master devices of this embodiment is described in detail below. A communication process of the slave device 120, the plurality of second master devices 210, and the second arbitration logic controller 230 in the subsystem 1, and a communication process of the slave device 120, the plurality of second master devices 240, and the arbitration logic controller 250 in the subsystem 2 are similar to the communication process of the salve device 120, the plurality of master devices 110, and the arbitration logic controller 130 in the access arbitration system 100.

In some embodiments, the master device 110 sends the access request for the I2C bus access permission in a manner in which a register is read and written by a bus, or the master device 110 sends the access request for the I2C bus access permission through a general-purpose input/output port.

That is, in some embodiments, a communication channel between the master device 110 and the arbitration logic controller 130 and a communication channel between the arbitration logic controller 230 in the subsystem 1 and the arbitration logic controller 250 in the subsystem 2 may be I2C buses or other buses, which may be implemented in a manner in which a register is read or written, or in a manner in which a general-purpose input/output (GPIO) requests for interruption.

In some embodiments, the arbitration logic controller 130 is preferably, but not limited to, a control chip that can communicate with the plurality of master devices 110 and can independently determine logic. The arbitration logic controller 130 may be an IC such as a complex programmable logic device (CPLD), a baseboard management control (BMC), or a field-programmable gate array (FPGA), or may include a logic circuit that implements I2C arbitration.

In some embodiments, the arbitration logic controller 130 is used to arbitrate which master device 110 an I2C bus access permission belongs to, which can effectively avoid the problem of access conflicts in the I2C bus. I2C arbitration logic in this embodiment can be implemented on an existing logic control chip such as a CPLD/FPGA/BMC without additional hardware costs.

In addition, compared with an existing dedicated dual-channel I2C master selector (such as PCA9541), the arbitration logic controller 130 adopted in this embodiment has the advantages of low costs, no restrictions on the placement of parts, and no limitation on the number of I2C master devices 110. The existing dedicated dual-channel I2C master selector (such as PCA9541) needs to be placed at a connection point such as a backplane between systems. However, for reliability reasons, it is not recommended to place an active device on the backplane, and the PCA9541 can be connected to only two master devices.

In some embodiments, before establishing the communication connection with the slave device 120, the master device 110 detects whether a current I2C bus is occupied by another master device 110, if the current I2C bus is not occupied by the another master device 110, the master device 110 sends an access request for an I2C bus access permission to the arbitration logic controller 130, and if the current I2C bus is occupied by the another master device 110, after waiting for a preset time, the master device 110 re-detects whether the current I2C bus is occupied by the another master device 110.

Specifically, in some embodiments, an implementation in which before establishing the communication connection with the slave device 120, the master device 110 detects whether a current I2C bus is occupied by another master device 110 is as follows:

Before accessing the I2C bus, the master device 110 first communicates with the arbitration logic controller 130, to detect whether the current I2C bus has been occupied by another master device. A form of a register may define a specific bit of the register to represent an I2C status, the GPIO may use a plurality of pins to combine logic to represent the I2C status. For example, 000 represents that a system 1 is idle, 001 represents that the I2C bus is occupied by an I2C master device 1 of the system 1, 010 represents that the I2C bus is occupied by an I2C master device 2 of the system 1, and 101 represents that the I2C bus is occupied by an I2C master device 1 of the system 2. If the I2C bus has been occupied by another I2C master device, the request is continued after a specific period of time. If the I2C bus is not occupied by another master device, the register is written by a communication bus to represent the I2C bus access request or GPIO is written by a communication bus to send an interruption request, and the arbitration logic controller 130 determines, according to the access requests of the master devices 110, which master device 110 the current I2C bus access permission should be assigned to.

In some embodiments, after executing a communication task, the master device 110 that establishes the communication connection with the slave device 120 sends a release request for releasing an I2C bus access permission to the arbitration logic controller 130, and when receiving the release request, the arbitration logic controller 130 disconnects the communication connection between the master device 110 and the slave device 120.

That is, in some embodiments, when the master device 110 needs to access the slave device 120 on the I2C bus, the master device 110 needs to first apply to the arbitration logic controller 130 for the I2C bus access permission, and then determines, according to an arbitration result fed back by the arbitration logic controller 130, whether the master device 110 has a permission to occupy the I2C bus. After confirming that the I2C bus access permission is obtained, the master device 110 can establish a communication connection with the slave device 120 and perform read and write operations on the I2C bus. After performing the read and write operations, the master device 110 needs to release an I2C access request.

In some embodiments, an arbitration truth table is preset in the arbitration logic controller 130, and when receiving the access request from only one master device 110, the arbitration logic controller 130 determines, based on the arbitration truth table, whether to allow the master device 110 to establish a communication connection with the slave device 120.

In some embodiments, when the access arbitration system 100 for a plurality of I2C communication-based master devices includes at least two access arbitration subsystems, the arbitration truth table includes priorities of the access arbitration subsystems, and priorities of the master devices in each of the two access arbitration subsystems.

In some embodiments, access priorities of the master devices 110 are preset in the arbitration logic controller 130, and when receiving the access requests of at least two master devices 110, the arbitration logic controller 130 determines, based on the access priorities of the master devices 110, the master device 110 that establishes a communication connection with the slave device 120.

In some embodiments, when receiving the release request sent by the master device 110, the arbitration logic controller 130 determines, based on the access priorities of the master devices 110, a next master device 110 that establishes a communication connection with the slave device 120.

In this embodiment, an arbitration truth table is set in the arbitration logic controller 130. If only one master device 110 currently applies for access, the I2C access permission is granted, according to the arbitration truth table, to the master device 110 that currently applies for access. Currently, if a plurality of master devices 110 applies for access simultaneously, an access priority is preset by the arbitration logic controller 130, and each master device 110 is assigned a fixed priority. Subsequently, the arbitration logic controller 130 first grants an access permission to the master device 110 with the highest priority according to the priorities. Other master devices 110 continue to execute the access mechanism according to the priorities after waiting for the master device 110 with the highest authority to complete the access and release an arbitration request. After determining that the I2C bus access permission is obtained, the master device 110 may perform read and write operations on the I2C bus, and releases the access request after performing the read and write operations. In this case, the arbitration logic controller 130 may perform the next logic determination or directly perform the previous priority determination, for the I2C master device 110 with the second priority to obtain the access permission. By analogy, after the master device 110 with the second priority completes the access and releases the access request, priority determination is directly performed on the master device 110 with the third priority and the master devices 110 with subsequent priorities.

In some embodiments, an example of the arbitration truth table of six master devices in the subsystem 1 and the subsystem 2 is shown in Table 1.

TABLE 1
Arbitration truth table

| | Request | Request | Request | Sum of | |
|---|---|---|---|---|---|
| | access | access | access | request | |
| | bit for a | bit for a | bit for a | access | |
| System | master | master | master | of a | |
| ID | device 3 | device 2 | device 1 | system | Arbitration result |
| 01 | x | x | 1 | 1 | When the subsystem 1 and the subsystem 2 |
| | | | | | access a slave device simultaneously, a |
| | | | | | master device 1 of the subsystem 1 has the |
| | | | | | highest priority, and the master device 1 of |
| | | | | | the subsystem 1 obtains an I2C access |
| | | | | | permission |
| 10 | x | x | 1 | 1 | When the subsystem 1 and the subsystem 2 |
| | | | | | access the slave device simultaneously, a |
| | | | | | priority of a master device of the subsystem |
| | | | | | 2 is lower than that of the master device of |
| | | | | | the subsystem 1, and the subsystem 1 is |
| | | | | | waited to release access permission |
| x | x | x | 1 | 0 | When a master device of only one system |
| | | | | | accesses the slave device, the master |
| | | | | | device 1 has the highest priority |
| 01 | x | 1 | 0 | 1 | When the subsystem 1 and the subsystem 2 |
| | | | | | access the slave device simultaneously, a |
| | | | | | priority of a master device 2 of the |
| | | | | | subsystem 1 is higher than that of the master |
| | | | | | device of the subsystem 2, and the master |
| | | | | | device of the subsystem 2 obtains the |
| | | | | | access permission |
| 10 | x | 1 | 0 | 1 | When the subsystem 1 and the subsystem 2 |
| | | | | | access the slave device simultaneously, a |
| | | | | | priority of a master device of the subsystem |
| | | | | | 2 is lower than that of the master device of |
| | | | | | the subsystem 1, and the subsystem 1 is |
| | | | | | waited to release access permission |
| x | x | 1 | 0 | 0 | When a master device of only one |
| | | | | | subsystem accesses the slave device, and |
| | | | | | the master device 1 does not apply for a |
| | | | | | request, the master device 2 has priority in |
| | | | | | access |
| 01 | 1 | 0 | 0 | 1 | When the subsystem 1 and the subsystem 2 |
| | | | | | access the slave device simultaneously, a |
| | | | | | priority of a master device 3 of the |
| | | | | | subsystem 1 is higher than that of the master |
| | | | | | device of the subsystem 2, and the master |
| | | | | | device 3 of the subsystem 1 obtains the |
| | | | | | access permission |
| 10 | 1 | 0 | 0 | 1 | When the subsystem 1 and the subsystem 2 |
| | | | | | access the slave device simultaneously, a |
| | | | | | priority of a master device of the subsystem |
| | | | | | 2 is lower than that of the master device of |
| | | | | | the subsystem 1, and the subsystem 1 is |
| | | | | | waited to release access permission |
| x | 1 | 0 | 0 | 0 | When a master device of only one system |
| | | | | | accesses the slave device, and the master |
| | | | | | devices 1 and 2 do not apply for requests, |
| | | | | | the master device 3 may access the slave |
| | | | | | device |
| x | 0 | 0 | 0 | x | When no master device of the system |
| | | | | | applies for a request, the system is in an idle |
| | | | | | state |

1. System ID: 01 represents the subsystem 1, 10 represents the subsystem 2, and x represents any status
2. Access request bit: 1 represents request, 0 represents that there is no request, and x represents any status
3. The sum of the request access of the system is a combination of access bits of all the master devices of the system. That any master device requests access is set in this bit.
4. Arbitration priority: subsystem 1 > subsystem 2, and master device 1 > master device 2 > master device 3

According to Table 1, in this embodiment, input data of the arbitration truth table is based on the combination of the access requests of the master devices in the subsystem 1 and the system subsystem 2, and the arbitration logic controller 130 determines an arbitration result according to the inputs combined with a system ID of the arbitration logic controller 130 by default. A sequence of priorities in the arbitration truth table may be customized. I2C arbitration requests of the system may be in a form of a sum or divided individually. The arbitration requests of the system are in the form of the sum in the figure. If the arbitration requests are divided individually for enumeration, a priority of each master device may be defined individually.

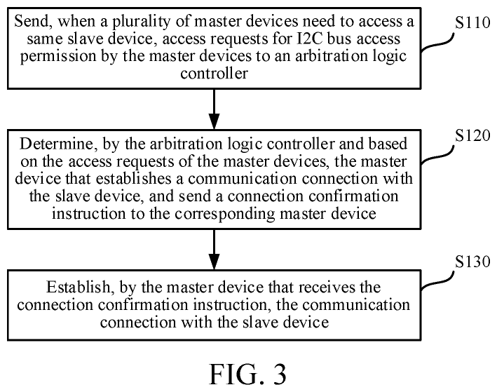

As shown in FIG. 3, an embodiment of the present disclosure further provides an access arbitration method for a plurality of I2C communication-based master devices. The method applies the access arbitration system 100 for the plurality of I2C communication-based master devices, and the method includes the following steps:

Step S110. Send, when a plurality of master devices needs to access a same slave device, access requests for I2C bus access permissions by the master devices to an arbitration logic controller.

Step S120. Determine, by the arbitration logic controller and based on the access requests of the master devices, the master device that establishes a communication connection with the slave device, and send a connection confirmation instruction to the corresponding master device.

Step S130. Establish, by the master device that receives the connection confirmation instruction, the communication connection with the slave device.

An implementation principle of the access arbitration method for a plurality of I2C communication-based master devices of this embodiment is the same as or similar to an implementation principle of the access arbitration system 100 for a plurality of I2C communication-based master devices, and details are not described herein again.

In summary, in the present disclosure, a problem of access conflicts caused by a plurality of I2C master devices accessing a slave device simultaneously can be avoided, thereby improving the reliability of system operation. Therefore, the present disclosure effectively overcomes defects in the related art, and has a high value in industrial use.

The above embodiments only exemplarily illustrate the principles and effects of the present disclosure, but are not used to limit the present disclosure. Any person skilled in the art may make modifications or changes on the foregoing embodiments without departing from the spirit and scope of the present disclosure. Therefore, all equivalent modifications or changes made by a person of ordinary skill in the art without departing from the spirit and technical idea of the present disclosure shall be covered by the claims of the present disclosure.

What is claimed is:

1. An access arbitration system for a plurality of inter-integrated circuit (I2C) communication-based master devices, comprising:
a slave device;
a plurality of master devices, respectively connected to the slave device through I2C buses; and
an arbitration logic controller, respectively connected to the plurality of master devices,
wherein when the master devices need to access the slave device, the master devices send access requests for an I2C bus access permission to the arbitration logic controller,
wherein the arbitration logic controller determines, based on the access requests of the master devices, the master device that establishes a communication connection with the slave device, and sends a connection confirmation instruction to the corresponding master device, and
wherein the master device that receives the connection confirmation instruction establishes the communication connection with the slave device.

2. The access arbitration system for the plurality of I2C communication-based master devices as in claim 1, comprising a plurality of access arbitration subsystems; each of the plurality of access arbitration subsystems comprises a plurality of second master devices and a second arbitration logic controller connected to the plurality of second master devices; the second arbitration logic controllers in the plurality of access arbitration subsystems are in communication connection with each other; and the second master devices in the plurality of access arbitration subsystems are respectively connected to the slave device through the I2C buses.

3. The access arbitration system for the plurality of I2C communication-based master devices as in claim 1, wherein before establishing the communication connection with the slave device, the master device detects whether a current I2C bus is occupied by another master device, if the current I2C bus is not occupied by the another master device, the master device sends an access request for an I2C bus access permission to the arbitration logic controller, and if the current I2C bus is occupied by the another master device, after waiting for a preset time, the master device re-detects whether the current I2C bus is occupied by the another master device.

4. The access arbitration system for the plurality of I2C communication-based master devices as in claim 1, wherein the master device sends the access request for the I2C bus access permission in a manner in which a register is read and written by a bus, or the master device sends the access request for the I2C bus access permission through a general-purpose input/output port.

5. The access arbitration system for the plurality of I2C communication-based master devices as in claim 3, wherein the master device sends the access request for the I2C bus access permission in a manner in which a register is read and written by a bus, or the master device sends the access request for the I2C bus access permission through a general-purpose input/output port.

6. The access arbitration system for the plurality of I2C communication-based master devices as in claim 1, wherein an arbitration truth table is preset in the arbitration logic controller, and when receiving the access request from one of the plurality of master devices, the arbitration logic controller determines, based on the arbitration truth table, whether to allow the one of the plurality of master devices to establish a communication connection with the slave device.

7. The access arbitration system for the plurality of I2C communication-based master devices as in claim 2, wherein an arbitration truth table is preset in the second arbitration logic controller, and when receiving an access request from one of the plurality of second master devices, the second arbitration logic controller determines, based on the arbitration truth table, whether to allow the one of the plurality of second master devices to establish a communication connection with the slave device.

8. The access arbitration system for the plurality of I2C communication-based master devices as in claim 6, wherein when the access arbitration system for the plurality of I2C communication-based master devices comprises at least two access arbitration subsystems, the arbitration truth table comprises priorities of the access arbitration subsystems and priorities of the master devices in each of the access arbitration subsystems.

9. The access arbitration system for the plurality of I2C communication-based master devices as in claim 6, wherein access priorities of the master devices are preset in the arbitration logic controller, and when receiving the access requests of at least two master devices, the arbitration logic controller determines, based on the access priorities of the master devices, the master device that establishes a communication connection with the slave device.

10. The access arbitration system for the plurality of I2C communication-based master devices as in claim 9, wherein after executing a communication task, the master device that establishes the communication connection with the slave device sends a release request for releasing an I2C bus access permission to the arbitration logic controller, and when receiving the release request, the arbitration logic controller disconnects the communication connection between the master device and the slave device.

11. The access arbitration system for the plurality of I2C communication-based master devices as in claim 10, wherein when receiving the release request sent by the master device, the arbitration logic controller determines, based on the access priorities of the master devices, a next master device that establishes a communication connection with the slave device.

12. An access arbitration method for a plurality of inter-integrated circuit (I2C) communication-based master devices, comprising:
sending, when a plurality of master devices needs to access a same slave device, access requests for I2C bus access permissions by the master devices to an arbitration logic controller;
determining, by the arbitration logic controller and based on the access requests of the master devices, the master device that establishes a communication connection with the slave device, and sending a connection confirmation instruction to the corresponding master device; and
establishing, by the master device that receives the connection confirmation instruction, the communication connection with the slave device.
